(19) United States
(12) Patent Application Publication
(10) Pub. No.: US 2010/0321562 A1
(43) Pub. Date: Dec. 23, 2010

(54) LENS HOLDER MODULE AND CAMERA MODULE UTILIZING THE SAME

(75) Inventor: JEN-TSORNG CHANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/701,705

(22) Filed: Feb. 8, 2010

(30) Foreign Application Priority Data
Jun. 19, 2009 (CN) 200910303441.8

(51) Int. Cl. H04N 5/225; G02B 7/02

(52) U.S. Cl. 348/374; 359/819; 348/E05.024

(57) ABSTRACT

A lens holder module includes a holder and an optical element. The holder has a peripheral sidewall. The peripheral sidewall has a first connection portion formed on an inner surface thereof. The optical element is received in the holder and spaced a distance from the first connection portion. The optical element has a top surface facing the first connection portion. At least one slot is recessed below on the inner surface and located between the first connection portion and the optical element. The at least one slot is proximate to the top surface of the optical element. The width of the at least one slot along an axis of the holder is from 0.01 to 0.2 mm.

### BACKGROUND

1. Technical Field

The present disclosure relates to optical imaging technology, and particularly to a dustproof lens holder module and a camera module utilizing the lens holder module.

2. Description of Related Art

With the ongoing development of optical imaging technology, camera modules are now widely used in a variety of electronic devices, such as mobile phones and personal digital assistants (PDAs).

A frequently used camera module includes a lens barrel, a lens holder, and an image sensor. The holder includes an internal thread, and the barrel includes an external thread. The internal thread of the holder engages the external thread of the barrel. When the barrel is threaded into the holder, dust located in the threads can be deposited onto the image sensor, affecting image quality.

Therefore, a holder and a camera module which can overcome the limitations described are desirable.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a schematic, cutaway isometric view of a lens holder module according to a first embodiment of the disclosure.

FIG. 2 is a schematic, cutaway isometric view of a lens holder module according to a second embodiment of the disclosure.

FIG. 3 is a schematic, cutaway isometric view of a lens holder module according to a third embodiment of the disclosure.

FIG. 4 is a schematic, cutaway isometric view of a camera module according to the disclosure.

### DETAILED DESCRIPTION

Various embodiments will now be described in detail below with reference to the drawings.

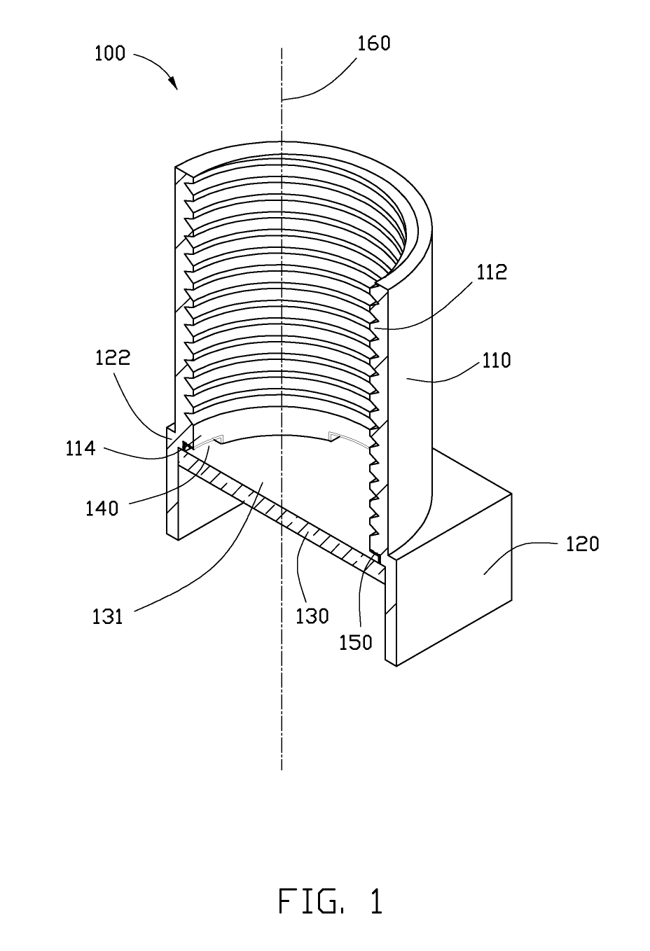

Referring to FIG. 1, a lens holder module 100 according to a first embodiment is shown. The lens holder module 100 includes a holder 101 and an optical element 130 received in the holder 101. The holder 101 includes a sleeve body 110 and a sensor housing 120 communicating therewith, and an end portion 122 of the sensor housing 120 connected to the sleeve body 110. In the present embodiment, the sleeve body 110 is a cylinder, and the sensor housing 120 is cuboid, and the sleeve body 110 is narrower than the sensor housing 120. The sleeve body 110 has a peripheral sidewall, on an inner surface 114 of which a first connection portion 112 is formed. The first connection portion 112 is configured for engaging a barrel (not shown). In the present embodiment, the first connection portion 112 has an internal thread. In another embodiment, the first connection portion 112 can be a slide rail configured to be received in a slide groove of a barrel. It can be understood that the shape of the sleeve body 110 or the sensor housing 120 is not limited to the present embodiment.

The optical element 130 is received in the sensor housing 120 of the holder 101. The optical element 130 contacts the end portion 122 of the sensor housing 120. The optical element 130 includes a top surface 131 facing the first connection portion 112. In the present embodiment, the optical element 130 is a glass filter.

Four slots 140 are located at a joining portion between the sleeve body 110 and the sensor housing 120, and proximate to the top surface 131 of the optical element 130. In the present embodiment, the slots 140 are bounded by the inner surface 114 of the end portion 114 and the top surface 131 of the optical element 130, and are rectangular and equidistant from each other along a circumference of the end portion 122 of the sensor housing 120. The width of the slots 140 along an axis 160 of the sleeve body 110 is a constant from 0.01 to 0.2 mm. The depth of each slot 140 perpendicular to the axis 160 direction of the sleeve body 110 can be set according to the requirements of application. It can be understood only one slot 140 need be located at the joining portion between the sleeve body 110 and the sensor housing 120.

A layer of adhesive material 150 is applied on an inner surface of each slot 140. The adhesive material 150 is configured for capturing dust.

When a barrel is rotated into the holder 101, dust from the first connection portion 112 of the holder 101 is deposited on the optical element 130 below, with shaking or vibrating the barrel and the holder 101 during transportation or operation can further agitate the dust into the slots 140. Since each slot 140 is from 0.01 mm to 0.2 mm wide, dust received in the slots 140 cannot be easily retrieved. Thus, holder 101 can decrease the impact of dust upon the image sensor and improve the image quality.

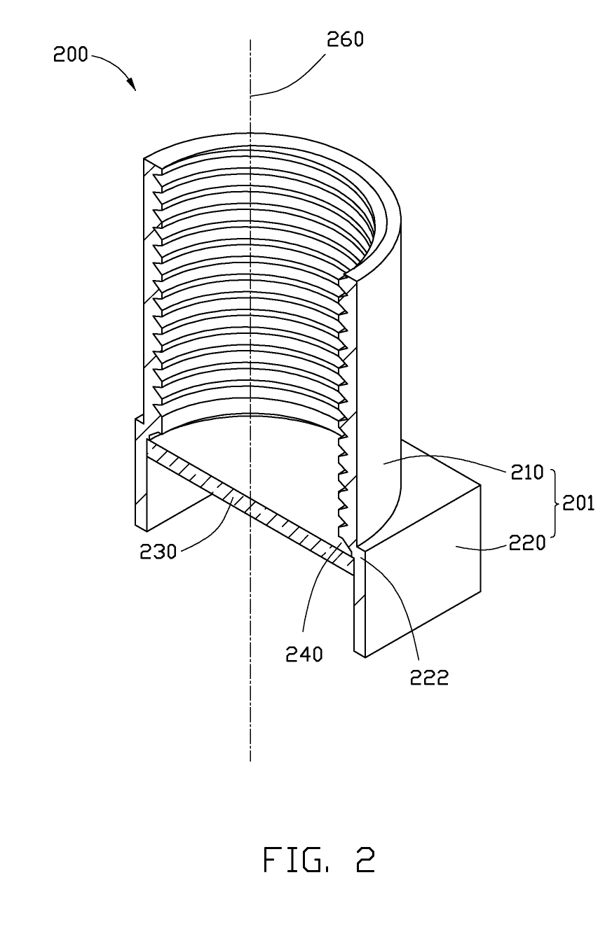

Referring to FIG. 2, a lens holder module 200 according to a second embodiment is shown, differing from lens holder module 100 only in the inclusion of a holder 201 and an optical element 230 received in the holder 201. The holder 201 includes a sleeve body 210 and a sensor housing 220 communicating with the sleeve body 210. Only one slot 240 is located at a joining portion between the sleeve body 210 and the sensor housing 220. Width of the slot 240 gradually decreases from axis 260 to the periphery of the sleeve body 210.

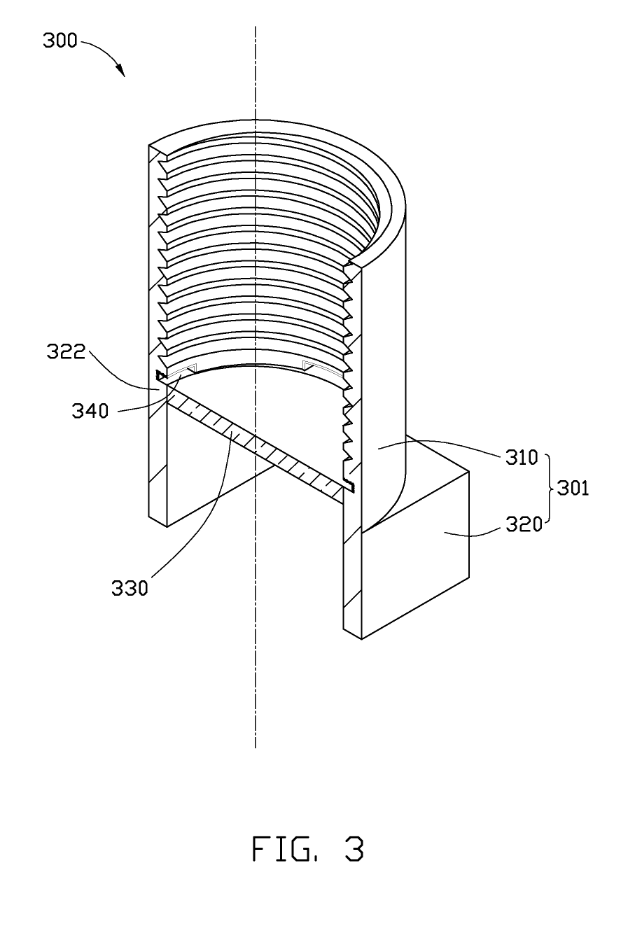

Referring to FIG. 3, a lens holder module 300 according to a third embodiment is shown, differing from the lens holder module 100 only in that width of the sleeve body 310 equals that of the sensor housing 320. Four slots 340 are located at a joining portion between the sleeve body 310 and the sensor housing 320. The slots 340 are equidistant from each other along a circumference of the end portion 322 of the holder 301.

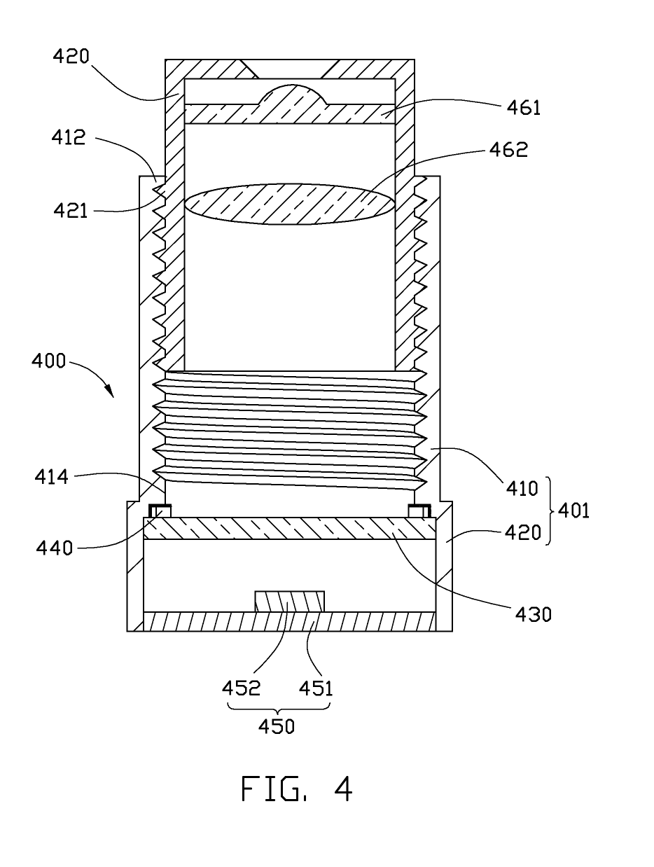

Referring to FIG. 4, a camera module 400 is shown. The camera module 400 includes a lens holder module 400, a barrel 420 received in the lens holder module 400, a first and second lens 461, 462 received in the barrel 420, an image sensor assembly 450 mounted at an end of the lens holder module 400, and an optical element 430 located in the hold module 400 and arranged between the image sensor assembly 450 and the barrel 420. In the present embodiment, the lens holder module 400 is the same as the lens holder module 100.

The lens holder module 400 includes a sleeve body 410 and a sensor housing 420. The sleeve body 410 includes a first connection portion 412 formed on an inner surface 414 of the peripheral sidewall. The barrel 420 includes a second connection portion 421 formed on an inner wall thereof. The second connection portion 421 engages the first connection portion 412 of the sleeve body. In the present embodiment, the second connection portion 421 has an external thread.

The image sensor assembly 450 is mounted at an end of the sensor housing 420, and includes a printed circuit board 451 and an image sensor 452 mounted thereon. The image sensor 452 faces the optical element 430. The image sensor 452 can be, for example, a charge coupled device (CCD) sensor or complementary metal oxide semiconductor transistor (CMOS) sensor.

When the barrel 420 is threaded into the holder 401, dust between the first connection portion 412 of the holder 401 and the second connection portion 421 of the barrel 420 is deposited on the optical element 430 below. Movement of the camera module 400 during transportation can further agitate the dust into the slots 440. Due to the narrowness of each slot the dust cannot be easily retrieved. Thus, holder 401 can reduce the impact of dust on the image sensor, and the image quality of the camera module 400 is improved.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A lens holder module comprising:
a holder comprising a peripheral sidewall, the peripheral sidewall comprising a first connection portion formed on an inner surface thereof, the first connection portion configured for engaging a barrel;
an optical element received in the holder and spaced a distance from the first connection portion, the optical element comprising a top surface facing the first connection portion, and
at least one slot recessed below on the inner surface and located between the first connection portion and the optical element, proximate to the top surface of the optical element, with a width of from 0.01 to 0.2 mm along a central axis of the holder.

2. The lens holder module of claim 1, wherein the peripheral sidewall forms a sleeve body and a sensor housing communicating with the sleeve body, and the at least one slot is located at a joining portion between the sleeve body and the sensor housing.

3. The lens holder module of claim 1, wherein the peripheral sidewall forms a sleeve body and a sensor housing communicating with the sleeve body, wherein the sleeve body is narrower than the sensor housing.

4. The lens holder module of claim 3, wherein the sensor housing comprises an end portion connected to the sleeve body, the optical element contacts the end portion, and the at least one slot is bounded by the inner surface of the end portion and the top surface of the optical element.

5. The lens holder module of claim 1, further comprising a layer of adhesive material applied on an inner surface of the at least one slot.

6. The lens holder module of claim 1, wherein width of the at least one slot along the axis of the holder is a constant.

7. The lens holder module of claim 1, wherein width of the at least one slot gradually decreases from the central axis to the periphery of the sleeve body.

8. The lens holder module of claim 1, further comprising a plurality of slots equidistant from each other along a circumference of the holder.

9. The lens holder module of claim 1, wherein the at least one slot is around the inner surface of the holder.

10. A camera module comprising:
a barrel comprising a first connection portion formed on an inner wall thereof;
at least one lens received in the barrel;
a lens holder module comprising a holder and an optical element, the holder comprising a peripheral sidewall, the peripheral sidewall including a second connection portion formed on an inner surface thereof, the second connection portion configured for engaging the first connection portion of the barrel, wherein the optical element is received in the holder and spaced a distance from the second connection portion, the optical element comprising a top surface facing the second connection portion; and at least one slot recessed below on the inner surface between the first connection portion and the optical element, the at least one slot being proximate to the top surface of the optical element, wherein the width of the at least one slot along a central axis of the lens barrel holder is in the range from 0.01 to 0.2 mm.

11. The camera module of claim 10, further comprising a layer of adhesive material applied on an inner surface of the at least one slot.

12. The camera module of claim 10, wherein the peripheral sidewall of the holder forms a sleeve body and a sensor housing communicating with the sleeve body, and the at least one slot is located at a joining portion between the sleeve body and the sensor housing.

13. The camera module of claim 10, further comprising a plurality of slots equidistant from each other along a circumference of the holder.

14. The camera module of claim 10, wherein the at least one slot is around the inner wall of the holder.
